(19) United States
(12) Patent Application Publication
(10) Pub. No.: US 2009/0126486 A1
(43) Pub. Date: May 21, 2009

(54) ORIENTATION INDEPENDENT GRAVITY SENSOR

(75) Inventors: Daniel T. Georgi, Houston, TX (US); Carl M. Edwards, Katy, TX (US); Sheng Fang, Houston, TX (US); Rocco DiFoggio, Houston, TX (US); Robert Estes, Tomball, TX (US)

Correspondence Address: CANTOR COLBURN LLP- BAKER ATLAS, 20 Church Street, 22nd Floor, Hartford, CT, 06103, US

(73) Assignee: BAKER HUGHES INCORPORATED, Houston, TX (US)

(21) Appl. No.: 11/943,200

(22) Filed: Nov. 20, 2007

(51) Int. Cl. G01V 7/00

(52) U.S. Cl. 73/382 R; 702/6

(57) ABSTRACT

An instrument for measuring gravitational acceleration, the instrument including: a plurality of accelerometers disposed about a three-dimensional structure, the plurality of accelerometers providing output used for measuring the gravitational acceleration; wherein each accelerometer in the plurality is implemented by at least one of a micro-electromechanical system (MEMS) and a nano-electromechanical system (NEMS).

### BACKGROUND OF THE INVENTION

1. Field of the Invention

The invention disclosed herein relates to well logging instruments and, in particular, to a gravity sensor.

2. Description of the Related Art

In exploration for hydrocarbons, it is important to make accurate measurements of properties of geologic formations. In particular, it is important to determine the various properties with a high degree of accuracy so that drilling resources are used efficiently.

Generally, oil and gas are accessed by drilling a borehole into the subsurface of the earth. The borehole also provides access for taking measurements of the geologic formations.

Well logging is a technique used to take measurements of the geologic formations from the borehole. In one embodiment, a “logging instrument” is lowered on the end of a wireline into the borehole. The logging instrument sends data via the wireline to the surface for recording. Output from the logging instrument comes in various forms and may be referred to as a “log.” Many types of measurements are made to obtain information about the geologic formations. One type of measurement involves determining gravitational force or gravity.

Measurements of gravity can be used to determine information related to the mass of a surrounding formation. For example, measurements of gravity can be used to measure depletion of oil in the surrounding formation as water replaces the oil. When water replaces oil in the formation, the mass of the formation and, therefore, a gravitational force exerted by the formation will increase because water is denser than oil.

Measurements of gravity can also be used to determine true vertical depth in the borehole. The true vertical depth is important to know because borehole depth is a common factor among various logs. The various logs may be viewed side-by-side to form a composite picture of the geologic formations. Even small errors in determining the borehole depth can corrupt logging data. Horizontal deviations of the borehole, which can corrupt the logging data, can be accounted for by determining the true vertical depth using gravitational measurements.

An accelerometer may be used to measure gravity. The accelerometer used to measure gravity requires high accuracy and high precision. Reservoir monitoring is one application requiring the measurement of gravity with high accuracy and precision. Reservoir monitoring involves determining the density of a formation through a borehole casing. The accelerometer used for reservoir monitoring is required to measure gravity to one part in 10⁹ or to within about 10⁻⁶ cm/s². For comparison, at the earth's surface, gravity is approximately 980 cm/s².

An accelerometer with the accuracy and the precision necessary to measure gravity for reservoir monitoring may be susceptible to noise and random drift in the borehole. In turn, noise and random drift can detract from the accuracy and the precision of the accelerometer necessary to measure gravity.

Therefore, what are needed are techniques to measure gravity with high accuracy and precision. In particular, the techniques should decrease susceptibility to noise and random drift.

### BRIEF SUMMARY OF THE INVENTION

Disclosed is an embodiment of an instrument for measuring gravitational acceleration, the instrument including: a plurality of accelerometers disposed about a three-dimensional structure, the plurality of accelerometers providing output used for measuring the gravitational acceleration; wherein each accelerometer in the plurality is implemented by at least one of a micro-electromechanical system (MEMS) and a nano-electromechanical system (NEMS).

Also disclosed is one example of a method for determining gravitational acceleration, the method including: performing a measurement of gravitational acceleration with each accelerometer in a plurality of accelerometers, the plurality disposed about a three-dimensional structure; and determining a net value of the gravitational acceleration from the measurements; wherein each accelerometer in the plurality is implemented by at least one of a micro-electromechanical system (MEMS) and a nano-electromechanical system (NEMS).

Further disclosed is an embodiment of an apparatus for measuring gravitational acceleration in a borehole, the apparatus including: a logging instrument; a plurality of accelerometers disposed about a three-dimensional structure, the plurality of accelerometers providing output used for measuring the gravitational acceleration; and a data collector for providing measurement data to a user; wherein each accelerometer in the plurality is implemented by at least one of a micro-electromechanical system (MEMS) and a nano-electromechanical system (NEMS).

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a logging instrument in a borehole penetrating the earth;

FIG. 2 illustrates an exemplary embodiment of a sensor for measuring gravitational acceleration;

FIGS. 3A and 3B, collectively referred to as FIG. 3, illustrate an exemplary embodiment of an accelerometer;

FIG. 4 illustrates another exemplary embodiment of a sensor for measuring gravitational acceleration;

FIG. 5 illustrates a gravitational force vector;

FIG. 6 illustrates a spherical coordinate system;

FIG. 7 illustrates an exemplary embodiment of a computer coupled to the logging instrument; and

FIG. 8 presents one example of a method for measuring gravitational acceleration.

### DETAILED DESCRIPTION OF THE INVENTION

The teachings provide techniques to measure gravity or gravitational acceleration with high accuracy and high precision. The techniques decrease susceptibility to noise and random drift. In addition, the techniques can be used to measure orientation.

The techniques provide a sensor that includes a plurality of accelerometers disposed about a three-dimensional structure. “Disposed about” refers to the plurality of accelerometers being disposed at least one of on and in the three-dimensional structure. Each accelerometer of the plurality is used to make a measurement of gravity. The plurality of accelerometers provides a corresponding plurality of outputs related to the measurement of gravity. The outputs are combined to provide a measurement of gravity that is accurate and precise. By combining the outputs, the plurality of accelerometers provides a measurement of gravity that is less susceptible to noise and random drift than a measurement of gravity using only one accelerometer. In particular, noise and random drift can be reduced by the square root of the total number of accelerometers in the plurality. Accordingly, the techniques call for using hundreds of accelerometers in the plurality for a significant reduction of noise and random drift.

Some accelerometers measure a force in substantially one direction. These types accelerometers can measure a vector component of gravity that is in line with the substantially one direction of measurement of the accelerometer. Because a value of gravity measured by these types of accelerometers is dependent upon the orientation of the accelerometer with respect to the direction of gravitational force, the output of the directional accelerometer has to be corrected. The techniques include a method for correcting the outputs of these types of accelerometers. In addition, the techniques include a method for determining the orientation of the plurality of accelerometers with respect to the direction of gravitational force.

The techniques provide for summing the corrected outputs using a square root of the sum of the squares method. This method provides for the reduction in noise and random drift.

As used herein, the terms “gravity” and “gravitational acceleration” are interchangeable. The term “gravitational force” relates to the force exerted upon an object due to gravity. By knowing the mass of the object and the gravitational force exerted upon the object, the gravitational acceleration can be determined. An accelerometer measuring gravitational acceleration may include measuring gravitational force.

For convenience, certain definitions are provided. The term “housing” relates to a structure of a logging instrument. The housing may used to at least one of contain and support a device used with the logging instrument. The device can be the three-dimensional structure with the plurality of accelerometers. The term “three dimensional structure” relates to a structure requiring three dimensions to describe a location on the structure. The three-dimensional structure is part of the sensor. Accordingly, the three-dimensional structure is sized to fit within the housing of a logging instrument. The term “directional accelerometer” relates to an accelerometer that measures force of acceleration (and, therefore, acceleration) in substantially one direction. The term “net value for the gravitational acceleration” relates to a value of gravitational acceleration determined using the measurement of gravitational acceleration from each accelerometer in the plurality of accelerometers.

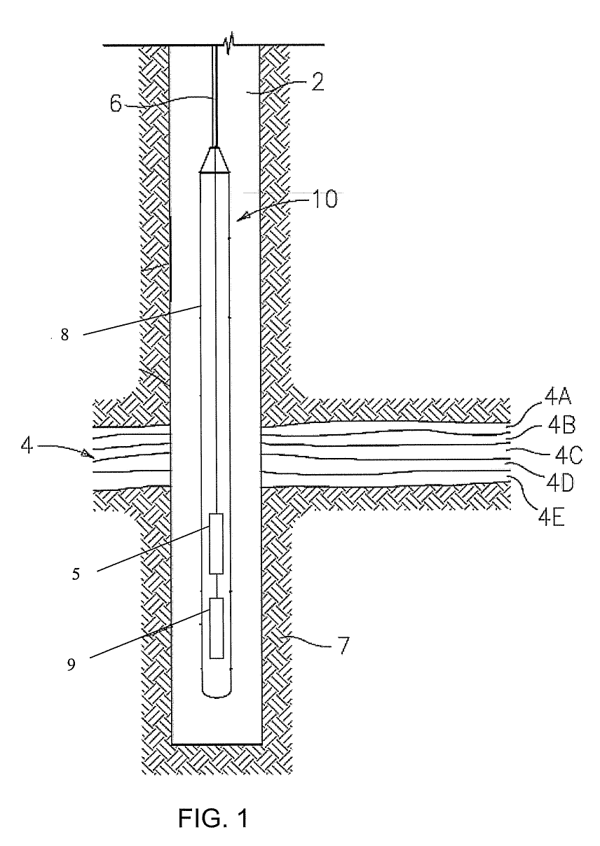

Referring to FIG. 1, one embodiment of a well logging instrument 10 is shown disposed in a borehole 2. The logging instrument 10 can be used for measuring gravity. The logging instrument 10 includes an instrument housing 8 adapted for use in the borehole 2. The borehole 2 is drilled through earth 7 and penetrates formations 4, which include various formation layers 4A-4E. The logging instrument 10 is generally lowered into and withdrawn from the borehole 2 by use of an armored electrical cable 6 or similar conveyance as is known in the art. In the embodiment of FIG. 1, a sensor 9 is shown disposed within the housing 8. The sensor 9 includes the plurality of accelerometers disposed about the three-dimensional structure. FIG. 1 also depicts an electronic unit 5 shown disposed within the housing 8. The electronic unit 5 processes an output from each accelerometer in the plurality of accelerometers included in the sensor 9. The electronic unit 5 processes the outputs to determine the gravitational acceleration at the sensor 9. The gravitational acceleration at the sensor 9 can be affected by the formations 4.

It will be recognized that the various features as may be encountered in a subsurface environment may be referred to as “formations.” Accordingly, it should be considered that while the term “formation” generally refers to geologic formations of interest, that the term “formations,” as used herein, may, in some instances, include any geologic points of interest (such as a survey area).

For the purposes of this discussion, it is assumed that the borehole 2 is vertical and that the formations 4 are horizontal. The teachings herein, however, can be applied equally well in deviated or horizontal wells or with the formation layers 4A-4E at any arbitrary angle. The teachings are equally suited for use in logging while drilling (LWD) applications, measurement while drilling (MWD) and in open-borehole and cased-borehole wireline applications. In LWD/MWD applications, the logging instrument 10 may be disposed in a drilling collar. When used in LWD/MWD applications, drilling may be halted temporarily to prevent vibrations while the plurality of accelerometers 3 is used to perform a measurement of at least one of gravity and orientation.

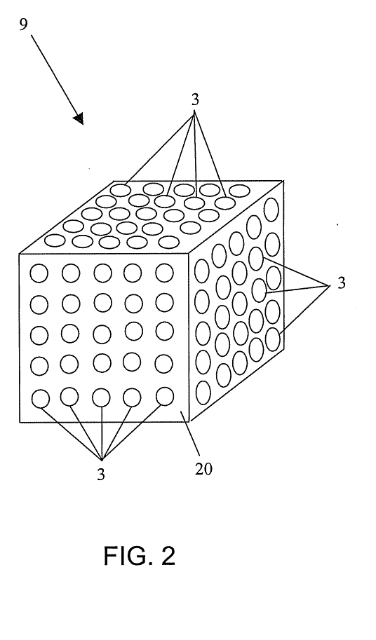

FIG. 2 illustrates an exemplary embodiment of the sensor 9. Referring to FIG. 2, a plurality of accelerometers 3 is disposed upon a three-dimensional structure 20. In the embodiment of FIG. 2, the three-dimensional structure has the shape of a cube. The three-dimensional structure 20 can also be other shapes, such as the curved shape depicted in a later embodiment for example, or a combination of shapes. As long as the position of each of the accelerometers 3 on the structure 20 is known, then any shape can be used. Referring to FIG. 2, the plurality of accelerometers 3 is shown disposed on three orthogonal sides of the structure 20. As discussed above, the techniques call for using hundreds of the accelerometers 3. In the embodiment of FIG. 2, the structure 20, shaped as a cube with a side dimension of about 2.54 centimeter (1 inch), can have over 100 of the accelerometers 3 on one side. Having such a large number of accelerometers 3 in a small area requires that the accelerometers 3 be built to at least one of nano-scale and micro-scale dimensions. Accelerometers 3 can be built to these small scales using solid state technology such as that used to fabricate semiconductor devices.

In one embodiment, the accelerometers 3 can be implemented by at least one of a Nano Electromechanical System (NEMS) and a Micro Electromechanical System (MEMS) as is known to those skilled in the art of NEMS and MEMS. In this embodiment, a proof mass is used to measure gravitational force. The proof mass is coupled to a diffraction grid such that at least one dimension of the diffraction grid changes with displacement of the proof mass. The diffraction grid is used along with a light source and a light detector to act as an interferometric displacement sensor. Light from the light source may be diffracted by the diffraction grid to provide diffracted light. Characteristics of the diffracted light can be measured by the light detector and correlated to the displacement of the proof mass to determine the gravitational force. By knowing the mass of the proof mass and the gravitational force, the gravitational acceleration can be determined.

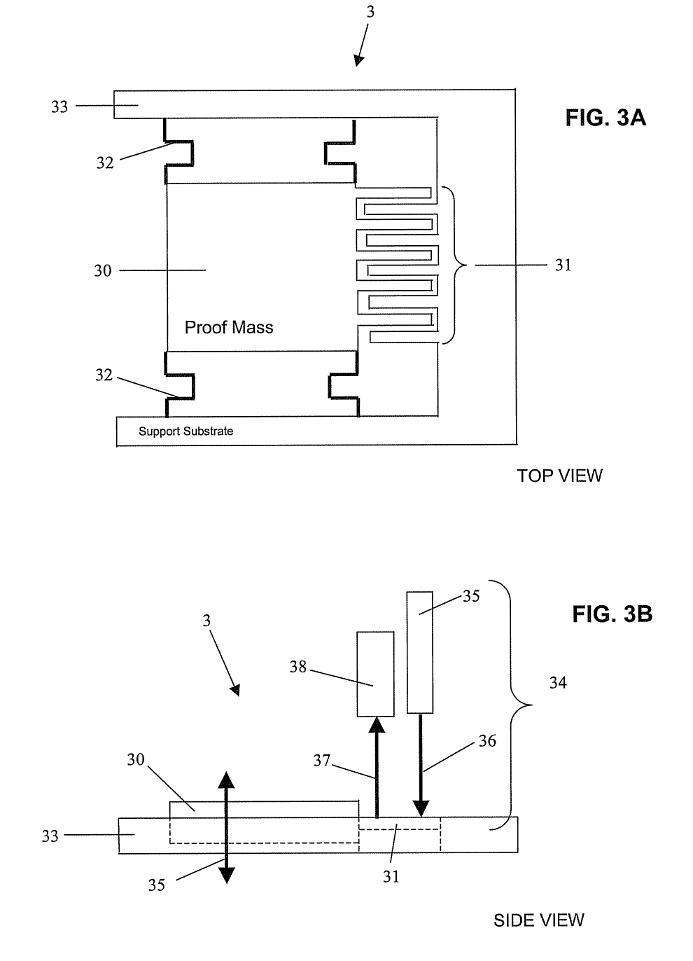

FIG. 3 illustrates an exemplary embodiment of one the accelerometers 3 that is implemented by at least one of a NEMS and a MEMS. A top view of the accelerometer 3 is depicted in FIG. 3A. Referring to FIG. 3A, the accelerometer 3 includes a proof mass 30 coupled to a diffraction grid 31. The proof mass 30 is suspended by springs 32 coupled to a support substrate 33. The springs 32 provide a counter-force to the force of gravity while allowing displacement of the proof mass 30 due to the force of gravity. In the embodiment depicted in FIG. 3A, the proof mass 30, the diffraction grid 31, and the springs 32 are implemented by at least one of the NEMS and the MEMS.

FIG. 3B illustrates a side view of the accelerometer 3. FIG. 3B depicts the accelerometer 3 with the light source and the light detector. The diffraction grid 31, a light source 35, and a light detector 38 form an interferometric displacement sensor 34. The light source 35 provides input light 36. The input light 36 diffracted off the diffraction grid 31 provides diffracted light 37. Referring to FIG. 3B, the springs 32 allow movement of the proof mass 30 in substantially direction 35. As the proof mass 30 moves, at least one dimension defining the diffraction grid 31 changes. In turn, intensity of a single mode of the diffracted light 37 is related to the at least one dimension. Thus, by measuring the intensity of the single mode of the diffracted light 37, displacement of the proof mass 30 can be determined. Further, the displacement can be correlated to an amount of gravitational force or gravitational acceleration imposed on the proof mass 30.

In one embodiment, the light source 35 can be implemented by a laser diode. In one embodiment, the light detector 38 can be implemented by a photodiode.

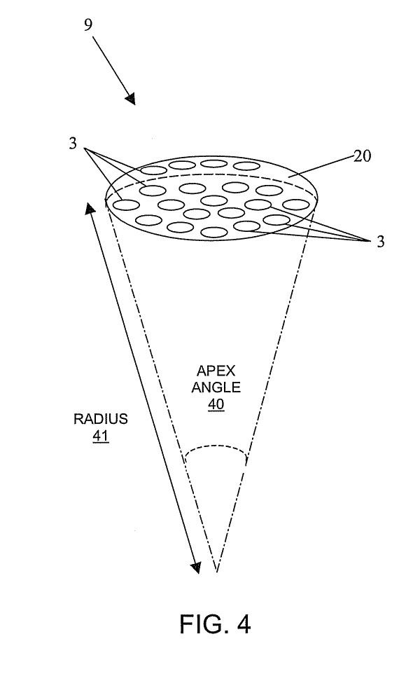

FIG. 4 illustrates an exemplary embodiment of the plurality of accelerometers 3 disposed upon the three-dimensional structure 20 that is a curved surface. The curved surface is a portion of the surface of a sphere. In the embodiment of FIG. 4, the portion of the sphere has an apex angle 40 of about four degrees and a radius 41 of about 21.38 mm (0.84 in), which is about the radius of a golf ball.

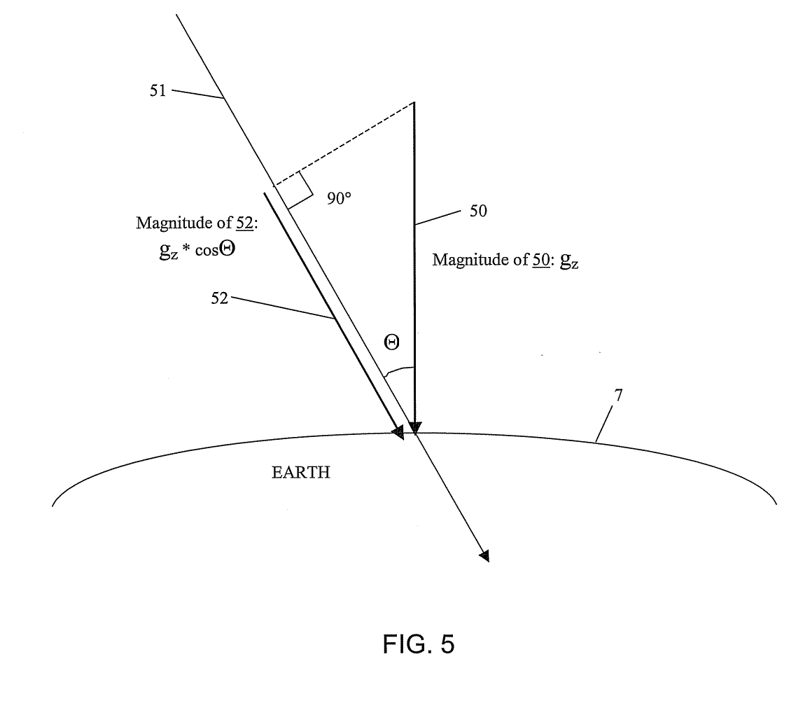

As discussed above, the accelerometers 3 that are directional can measure the vector component of gravitational force that is in line with the direction of measurement of the accelerometer 3. FIG. 5 presents a diagram illustrating a gravitational force vector 50 of magnitude g_{z}. FIG. 5 also presents a direction of measurement 51 of one of the plurality of accelerometers 3 that measures acceleration in substantially one direction. As shown in FIG. 5, a vector component 52 of the gravitational force vector 50 in line with the direction of measurement 51 is depicted. The direction of the gravitational force vector 50 is used to define the vertical direction on the earth 7 and within the borehole 2.

Referring to FIG. 5, the magnitude of the vector component 52 of the gravitational force vector 50 measured by one of the accelerometers 3 is g_{z}*cos (Θ) where Θ represents the angle between the vector component 52 and the gravitational force vector 50. Therefore, g_{z} can be determined by dividing the measurement of the accelerometer 3 by the cos (Θ).

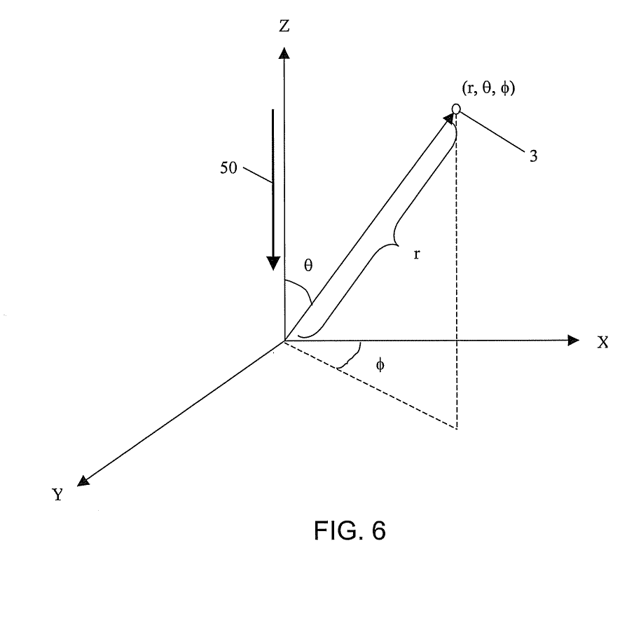

Corrections can be applied to the measurements performed by the plurality of accelerometers 3. The corrections use a spherical coordinate system as depicted in FIG. 6. The spherical coordinate system is used to indicate a location for each of the accelerometers 3. Referring to FIG. 6, the Z-axis is in line with the direction of the gravitational force vector 50. The angle θ measures the angle of the location from the Z-axis. The angle φ measures the angle of the location from the X-axis. The X-axis is assigned an arbitrary direction orthogonal to the Z-axis. The location of the i-th accelerometer of the plurality of accelerometers 3 is designated as (rᵢ, θᵢ, φᵢ).

For the embodiment of FIG. 4, if the curved surface rotates about the center of curvature such that the Z-axis of the rotated coordinate system is not in line with the direction of the gravitational force vector 50, then the effects of the rotation on the measurement of gravity can be taken into account by the following series of equations. A rotation matrix R may be used to represent the rotation of the spherical coordinate system. Equation (1) is the rotation matrix R using the spherical coordinate system of FIG. 6 where a represents the angle of rotation in the X-Z plane, and D is the angle of rotation in the X-Y plane.

$$R = ( \begin{matrix}cos α cos β & - sin β & - sin α cos β \\ cos α sin β & cos β & - sin α sin β \\ sin α & 0 & cos α\end{matrix} ) \qquad ( 1 )$$

Because the Z-axis of the rotated coordinate system is not in line with the gravitational force vector 50, the rotated coordinate system is rotated back to the original location before the rotation occurred. The rotated coordinate system can be rotated back by using the inverse of R, which is also the transpose of R. Equation (2) is used to calculate the rotation of the coordinate system back to the original coordinate system in rectangular coordinates.

$$( \begin{matrix}x \\ y \\ z\end{matrix} ) = ( \begin{matrix}cos α cos β & cos α sin β & sin α \\ - sin β & cos β & 0 \\ - sin α cos β & - sin α sin β & cos α\end{matrix} ) ( \begin{matrix}r sin θ cos φ \\ r sin θ sin φ \\ r cos θ\end{matrix} ) \qquad ( 2 )$$

Equation (2) can be expanded to determine the Z-component, z. Equation (3) is used to determine z.

z=r(cos α cos θ−sin α cos β sin θ cos φ−sin α sin β sin θ sin φ) (3)

Equation (3) can be used to represent the measurement of gravity, gᵢ, by the i-th accelerometer of the plurality of accelerometers 3 as shown in equation (4) where g_{z} is the magnitude of the gravitational force vector 50.

gᵢ=g_{z}(cos α cos θᵢ−sin α cos β sin θᵢ cos φᵢ−sin α sin β sin θᵢ sin φᵢ) (4)

Equation (4) can be simplified as shown in equation (5) where dᵢ, A, B, and C are defined in equations (6), (7), (8) and (9) respectively.

dᵢ=A cos θᵢ−B sin θᵢ cos φᵢ−C sin θᵢ sin φᵢ (5)

dᵢ=gᵢ (6)

A=g_{z} cos α (7)

B=g_{z} sin α cos β (8)

C=g_{z} sin α sin β (9)

An object function can be constructed from equations (5) through (9) as shown in equation (10).

$$ψ ( A , B , C ) = {\sum }_{i = 1}^{N} {( {d}_{i} - A cos {θ}_{i} + B sin {θ}_{i} + cos {φ}_{i} + C sin {θ}_{i} sin {φ}_{i} )}^{2} \qquad ( 10 )$$

By setting the derivative of the object function of equation (10) with respect to A, B, and C to zero, A, B, and C can be determined by solving equation (11).

$$( \begin{matrix}\sum {cos}^{2} {θ}_{i} \\ \sum sin {θ}_{i} cos {θ}_{i} cos {φ}_{i} \\ \sum sin {θ}_{i} cos {θ}_{i} sin {φ}_{i}\end{matrix} \begin{matrix}- \sum sin {θ}_{i} cos {θ}_{i} cos {φ}_{i} & - \sum sin {θ}_{i} cos {θ}_{i} sin {φ}_{i} \\ - \sum {sin}^{2} {θ}_{i} {cos}^{2} {φ}_{i} & - \sum {sin}^{2} {θ}_{i} sin {φ}_{i} cos {φ}_{i} \\ - \sum {sin}^{2} {θ}_{i} sin {φ}_{i} cos {φ}_{i} & - \sum {sin}^{2} {θ}_{i} {sin}^{2} {φ}_{i}\end{matrix} ) ( \begin{matrix}A \\ B \\ C\end{matrix} ) = ( \begin{matrix}\sum {d}_{i} cos {θ}_{i} \\ \sum {d}_{i} sin {θ}_{i} cos {φ}_{i} \\ \sum {d}_{i} sin {θ}_{i} sin {φ}_{i}\end{matrix} ) \qquad ( 11 )$$

The magnitude, g_{z}, of the gravitational force vector 50 can be calculated from equation (12).

g_{z}=\sqrt{A²+B²+C²} (12)

The angles α and β can also be calculated. Equation (13) is used to calculate α and equation (14) is used to calculate β.

$$\begin{matrix}α = {tan}^{- 1} \frac{\sqrt{{B}^{2} + {C}^{2}}}{A} & ( 13 ) \\ β = {tan}^{- 1} \frac{C}{B} & ( 14 )\end{matrix}$$

Generally, the well logging instrument 10 includes adaptations as may be necessary to provide for operation during drilling or after a drilling process has been completed.

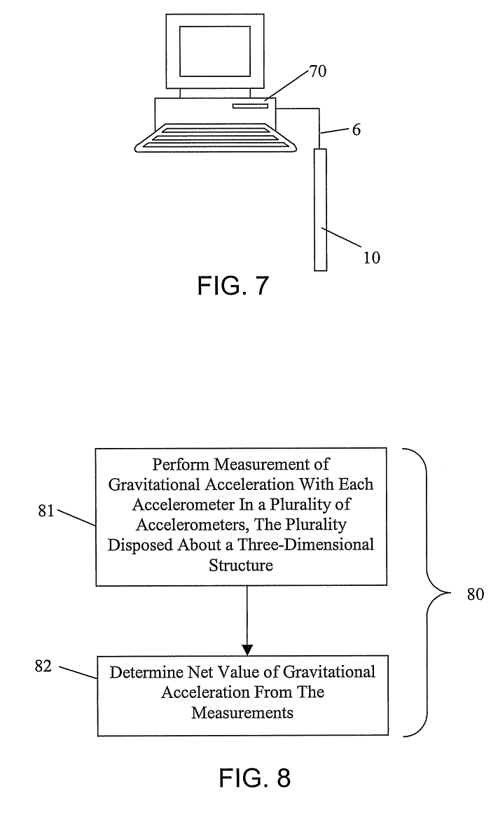

Referring to FIG. 7, an apparatus for implementing the teachings herein is depicted. In FIG. 7, the apparatus includes a computer 70 coupled to the well logging instrument 10. In general, the computer 70 includes components as necessary to provide for the real time processing of data from the well logging instrument 10. Exemplary components include, without limitation, at least one processor, storage, memory, input devices, output devices and the like. As these components are known to those skilled in the art, these are not depicted in any detail herein.

Generally, some of the teachings herein are reduced to an algorithm that is stored on machine-readable media. The algorithm is implemented by the computer 70 and provides operators with desired output. The output is typically generated on a real-time basis.

The logging instrument 10 may be used to provide real-time measurements of various parameters such as gravity for example. As used herein, generation of data in “real-time” is taken to mean generation of data at a rate that is useful or adequate for making decisions during or concurrent with processes such as production, experimentation, verification, and other types of surveys or uses as may be opted for by a user or operator. As a non-limiting example, real-time measurements and calculations may provide users with information necessary to make desired adjustments during the drilling process. In one embodiment, adjustments are enabled on a continuous basis (at the rate of drilling), while in another embodiment, adjustments may require periodic cessation of drilling for assessment of data. Accordingly, it should be recognized that “real-time” is to be taken in context, and does not necessarily indicate the instantaneous determination of data, or make any other suggestions about the temporal frequency of data collection and determination.

A high degree of quality control over the data may be realized during implementation of the teachings herein. For example, quality control may be achieved through known techniques of iterative processing and data comparison. Accordingly, it is contemplated that additional correction factors and other aspects for real-time processing may be used. Advantageously, the user may apply a desired quality control tolerance to the data, and thus draw a balance between rapidity of determination of the data and a degree of quality in the data.

FIG. 8 presents one example of a method 80 for determining gravitational acceleration in the borehole 2. The method 80 calls for performing (step 81) a measurement of gravitational acceleration with each of the accelerometers 3. Further, the method 80 calls for determining (step 82) a net value for the gravitational acceleration from the individual measurements.

In some embodiments of the plurality of accelerometers 3 and the three-dimensional structure 20, the plurality of accelerometers 3 are built into the three-dimensional structure 20. For example, the three-dimensional structure 20 may be a semiconductor, upon which the plurality of accelerometers 3 is built.

In certain embodiments, a string of two or more logging instruments 10 may be used where each logging instrument 10 includes at least the plurality of the accelerometers 3 disposed upon the three-dimensional structure 20. In these embodiments, a response from each logging instrument 10 may be used separately or combined with other responses to form a composite response.

In support of the teachings herein, various analysis components may be used, including digital and/or analog systems. The digital and/or analog systems may be used in the electronic unit 5 used for at least one of processing output and collecting data from each of the accelerometers 3. The electronic unit 5 may be disposed at least one of in the logging instrument 10 and at the surface of the earth 7. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, sensor, transmitter, receiver, transceiver, antenna, controller, lens, optical unit, light source, light detector, electrical unit or electromechanical unit may be included in support of the various aspects discussed herein or in support of other functions beyond this disclosure.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A sensor for measuring gravitational acceleration, the sensor comprising:
a plurality of accelerometers disposed about a three-dimensional structure, the plurality of accelerometers providing output used for measuring the gravitational acceleration;
wherein each accelerometer in the plurality is implemented by at least one of a micro-electromechanical system (MEMS) and a nano-electromechanical system (NEMS).

2. The sensor as in claim 1, wherein the sensor is disposed in a logging instrument.

3. The sensor as in claim 1, wherein the plurality of accelerometers measures acceleration in each dimension of the three-dimensional structure.

4. The sensor as in claim 1, wherein the at least one of the MEMS and the NEMS comprises an interferometric displacement sensor coupled to a proof mass for measuring the gravitational acceleration.

5. The sensor as in claim 4, further comprising at least one spring coupled to the proof mass and to a support substrate, the spring providing a counterforce to a force of gravity acting upon the proof mass.

6. The sensor as in claim 1, wherein the structure comprises three surfaces, each surface about orthogonal to the other surfaces.

7. The sensor as in claim 1, wherein the structure comprises at least a curved surface.

8. The sensor as in claim 1, wherein the plurality comprises a density of over one hundred accelerometers per square inch.

9. The sensor as in claim 1, wherein a portion of the plurality of accelerometers are disposed about the three-dimensional structure in relation to a direction for each of the three dimensions.

10. A method for determining gravitational acceleration, the method comprising:
performing a measurement of gravitational acceleration with each accelerometer in a plurality of accelerometers, the plurality disposed about a three-dimensional structure; and
determining a net value of the gravitational acceleration from the measurements;
wherein each accelerometer in the plurality is implemented by at least one of a micro-electromechanical system (MEMS) and a nano-electromechanical system (NEMS).

11. The method as in claim 10, wherein determining comprises correcting each individual measurement to account for measuring a fraction of gravitational acceleration in line with a direction of measurement.

12. The method as in claim 10, wherein determining comprises solving
g_{z}=\sqrt{A²+B²+C²}
where g_{z} represents the gravitational acceleration and A, B, and C are determined by solving
$$( \begin{matrix}\sum {cos}^{2} {θ}_{i} \\ \sum sin {θ}_{i} cos {θ}_{i} cos {φ}_{i} \\ \sum sin {θ}_{i} cos {θ}_{i} sin {φ}_{i}\end{matrix} \begin{matrix}- \sum sin {θ}_{i} cos {θ}_{i} cos {φ}_{i} & - \sum sin {θ}_{i} cos {θ}_{i} sin {φ}_{i} \\ - \sum {sin}^{2} {θ}_{i} {cos}^{2} {φ}_{i} & - \sum {sin}^{2} {θ}_{i} sin {φ}_{i} cos {φ}_{i} \\ - \sum {sin}^{2} {θ}_{i} sin {φ}_{i} cos {φ}_{i} & - \sum {sin}^{2} {θ}_{i} {sin}^{2} {φ}_{i}\end{matrix} ) ( \begin{matrix}A \\ B \\ C\end{matrix} ) = ( \begin{matrix}\sum {d}_{i} cos {θ}_{i} \\ \sum {d}_{i} sin {θ}_{i} cos {φ}_{i} \\ \sum {d}_{i} sin {θ}_{i} sin {φ}_{i}\end{matrix} ) \qquad ( 11 )$$
with respect to a spherical coordinate system used to locate each accelerometer of the plurality wherein the Z axis is the direction of the gravitational acceleration, θ is an angle measured from the Z axis, φ is an angle measured from an arbitrarily designated X axis, and dᵢ is the measurement of gravitational acceleration by the i-th of I accelerometers in the plurality.

13. The method as in claim 12, further comprising determining an angle of rotation, α, with respect to the Z-axis and an angle of rotation, β, with respect to the X-axis by calculating
$$\begin{matrix}α = {tan}^{- 1} \frac{\sqrt{{B}^{2} + {C}^{2}}}{A} and \\ β = {tan}^{- 1} \frac{C}{B} .\end{matrix}$$

14. The method as in claim 10, wherein determining comprises calculating a square root of the sum of the squares of each individual measurement.

15. An apparatus for measuring gravitational acceleration in a borehole, the apparatus comprising:
a logging instrument;
a plurality of accelerometers disposed about a three-dimensional structure, the plurality of accelerometers providing output used for measuring the gravitational acceleration; and
a data collector for providing measurement data to a user;
wherein each accelerometer in the plurality is implemented by at least one of a micro-electromechanical system (MEMS) and a nano-electromechanical system (NEMS).

16. The apparatus as in claim 15, further comprising a computer program product stored on machine-readable media for determining gravitational acceleration, the product comprising machine-executable instructions for:
performing a measurement of gravitational acceleration with each accelerometer in the plurality of accelerometers;
determining a net value of the gravitational acceleration from the measurements; and
collecting data from each accelerometer in the plurality.
